(19) United States
(12) Patent Application Publication
(10) Pub. No.: US 2002/0191226 A1
(43) Pub. Date: Dec. 19, 2002

(54) Call screening device for a facsimile machine

(76) Inventor: Chen-Peng Huang, Taichung (TW)

Correspondence Address: Ladas & Parry, Suite 1200, 224 South Michigan Avenue, Chicago, IL, 60604, US

(21) Appl. No.: 09/882,838

(22) Filed: Jun. 15, 2001

(51) Int. Cl. H04N 1/00

(52) U.S. Cl. 358/440

(57) ABSTRACT

A call screening device includes a switch circuit and a controller. The switch circuit is adapted to be connected to a facsimile machine and a telephone line. The controller is coupled electrically to the switch circuit and is adapted to be connected to the telephone line. The controller includes a data storage unit for storing telephone numbers, an incoming call detector adapted to detect a caller telephone number associated with an incoming call on the telephone line, and a comparator unit for making a comparison between the caller telephone number detected by the incoming call detector and the telephone numbers stored in the data storage unit, and for controlling the switch circuit to make or break connection between the facsimile machine and the telephone line according to the result of the comparison made by the comparator unit.

### BACKGROUND OF THE INVENTION

1. Field of the Invention

The invention relates to a peripheral device for a facsimile machine, more particularly to a call screening device for a facsimile machine.

2. Description of the Related Art

Presently, users of facsimile machines are experiencing increased burden due to the growing volume of unsolicited fax messages that are received almost daily. To solve this problem, some users turn off their facsimile machines when the latter are not in use, thereby preventing the receipt of unsolicited fax messages which waste paper resources. However, because the facsimile machines are normally turned off, a sending party has to inform a receiving party first, such as by placing a telephone call, before a fax message can be sent. Such a procedure is inconvenient for both the sending and receiving parties.

### SUMMARY OF THE INVENTION

Therefore, the main object of the present invention is to provide a call screening device for a facsimile machine which can prevent the receipt of unsolicited fax messages so as to conserve paper resources without the need to turn off the facsimile machine.

According to the present invention, a call screening device is adapted to interconnect a facsimile machine and a telephone line, and comprises:

a switch circuit adapted to be connected to the facsimile machine and the telephone line; and

a controller coupled electrically to the switch circuit and adapted to be connected to the telephone line, the controller including a data storage unit for storing telephone numbers, an incoming call detector adapted to detect a caller telephone number associated with an incoming call on the telephone line, and a comparator unit for making a comparison between the caller telephone number detected by the incoming call detector and the telephone numbers stored in the data storage unit, and for controlling the switch circuit to make or break connection between the facsimile machine and the telephone line according to result of the comparison made by the comparator unit.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram of the preferred embodiment of a call screening device for a facsimile machine according to the present invention;

FIG. 2 is a schematic circuit block diagram of a controller of the preferred embodiment;

FIG. 3 is a schematic circuit block diagram to illustrate a switch circuit of the preferred embodiment; and

FIG. 4 is a flowchart illustrating how an incoming call is processed by the preferred embodiment.

### DETAILED DESCRIPTION OF THE PREFERRED EMBODIMENT

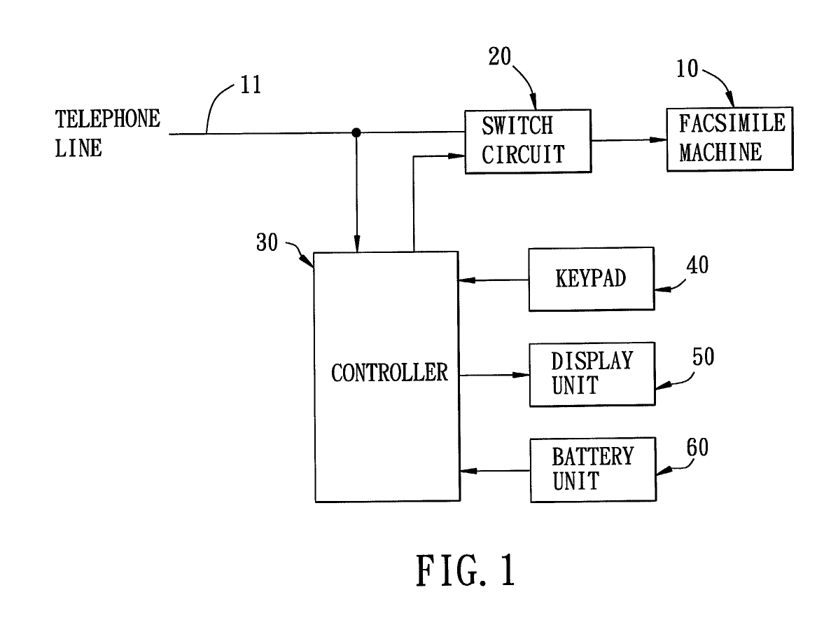

Referring to FIG. 1, the preferred embodiment of a call screening device according to the present invention is adapted to interconnect a facsimile machine 10 and a telephone line 11, and is shown to comprise a switch circuit 20, a controller 30, a keypad 40, a display unit 50, and a battery unit 60.

The switch circuit 20 is adapted to be connected to the facsimile machine 10 and the telephone line 11.

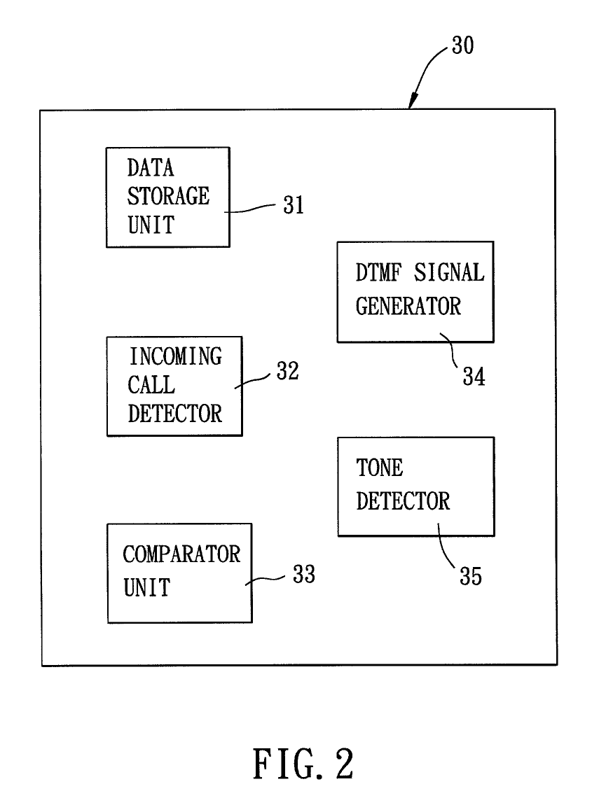

The controller 30 is coupled electrically to the switch circuit 20, and is adapted to be connected to the telephone line 11. With further reference to FIG. 2, the controller 30 is a commercially available controller, such as that available under the serial number EM78811, and includes a data storage unit 31, an incoming call detector 32, and a comparator unit 33.

The data storage unit 31 is a memory device that is used for storing telephone numbers.

Presently, telephone companies now offer caller identification services for telephone users. As such, an incoming call provided by the telephone company to a call recipient via the telephone line 11 generally includes a dual-tone multi-frequency (DTMF) signal that contains caller telephone number information and that is supplied prior to the ring signal.

The incoming call detector 32 is in the form of a DTMF decoder for detecting the caller telephone number that is associated with the incoming call on the telephone line 11. The DTMF decoder converts the DTMF signal received thereby from the telephone line 11 into a corresponding digital output for subsequent processing.

The comparator unit 33 is used for making a comparison between the caller telephone number detected by the incoming call detector 32 and the telephone numbers stored in the data storage unit 31, and for controlling the switch circuit 20 to make or break connection between the facsimile machine 10 and the telephone line 11 according to the result of the comparison made by the comparator unit 33.

In one embodiment, the telephone numbers stored in the data storage unit 31 are associated with rejected callers, and the comparator unit 33 controls the switch circuit 20 to break connection between the facsimile machine 10 and the telephone line 11 when the caller telephone number corresponds to one of the telephone numbers stored in the data storage unit 31.

In another embodiment, the telephone numbers stored in the data storage unit 31 are associated with non-rejected callers, and the comparator unit 33 controls the switch circuit 20 to maintain connection between the facsimile machine 10 and the telephone line 11 when the caller telephone number corresponds to one of the telephone numbers stored in the data storage unit 31.

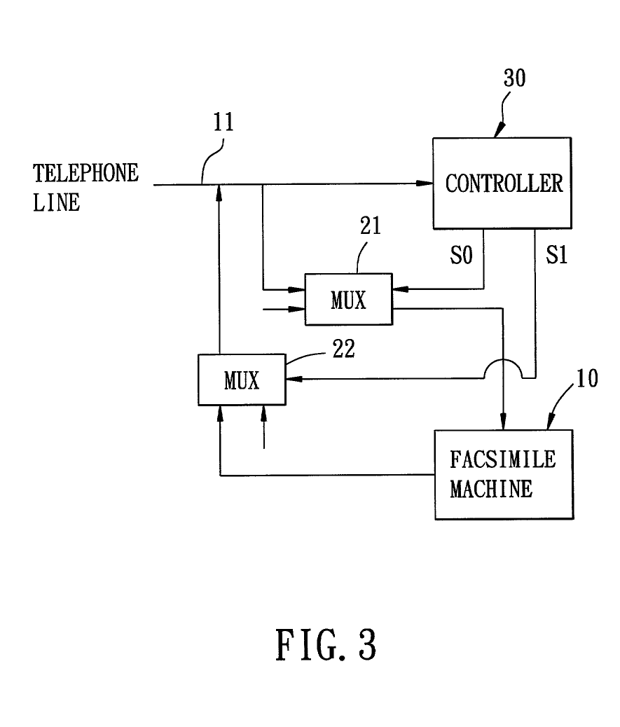

FIG. 3 illustrates a preferred implementation of the switch circuit 20. The switch circuit 20 is shown to include first and second two-input multiplexers 21, 22. The first two-input multiplexer 21 has a first input terminal connected to the telephone line 11, a floating second input terminal, a control terminal that is connected to the controller 30 so as to receive a select signal (S₀) therefrom, and an output terminal that is connected to the facsimile machine 10. The second two-input multiplexer 22 has a first input terminal connected to the facsimile machine 10, a floating second input terminal, a control terminal that is connected to the controller 30 so as to receive a select signal (S₁) therefrom, and an output terminal that is connected to the telephone line 11.

In the event of an incoming call, the select signal (S₀) generated by the controller 30 is at a low logic state such that the incoming signals on the telephone line 11 can be received by the facsimile machine 10 via the first two-input multiplexer 21 simultaneous with the receipt of the same by the controller 30. Upon detection by the controller 30 that the incoming call is associated with a non-rejected or recognized caller, the select signal (S₀) generated by the controller 30 is maintained at the low logic state so that the facsimile machine 10 can continue to receive the incoming signals on the telephone line 11. However, upon detection by the controller 30 that the incoming call is associated with a rejected or non-recognized caller, the select signal (S₀) generated by the controller 30 changes to a high logic state such that the facsimile machine 10 is disconnected from the telephone line 11. The facsimile machine 10 is thus prevented from receiving unsolicited fax messages to conserve paper resources.

On the other hand, the select signal (S1) generated by the controller 30 can be controlled to be at an appropriate state such that the facsimile machine 10 can be used to transmit an outgoing fax message or an outgoing telephone call to the telephone line 11 via the second two-input multiplexer 22.

Referring once again to FIG. 1, the keypad 40 is coupled electrically to the controller 30, and is operable so as to input the telephone numbers to be stored in the data storage unit 31. The display unit 50 is coupled electrically to and is controlled by the controller 30 to show the caller telephone number thereon. Preferably, the keypad 40 is further operable so as to enable the controller 30 to review the telephone numbers stored in the data storage unit 31 and to control the display unit 31 to show a reviewed one of the telephone numbers thereon. With the use of the keypad 40, the controller 30 can be further controlled to delete selected ones of the telephone numbers from the data storage unit 31.

Preferably, the controller 30 further includes a DTMF signal generator 34 for generating a DTMF signal corresponding to the telephone number shown on the display unit 50 for call back purposes.

In the preferred embodiment, the controller 30 normally operates in a sleep mode in order to conserve energy. In this regard, the controller 30 further includes a tone detector 35 that is adapted to detect the presence of an incoming tone signal on the telephone line 11, and to wake the controller 30 from the sleep mode upon detection of the incoming tone signal.

The battery unit 60 is coupled electrically to the controller 30 so as to supply electric power thereto.

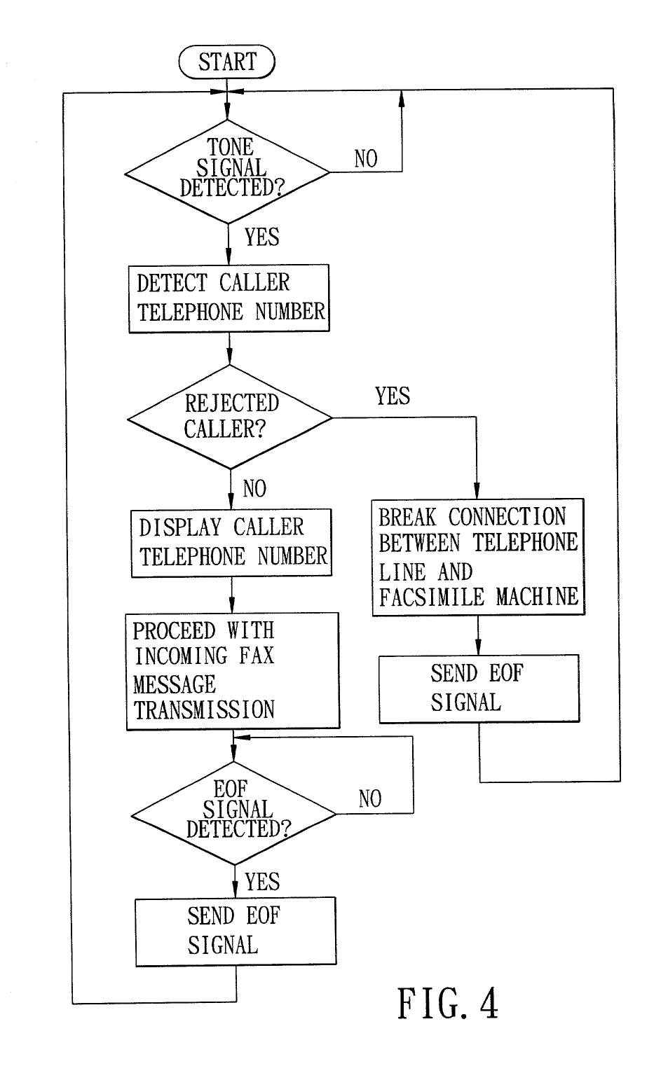

FIG. 4 is a flowchart illustrating how an incoming call is processed by the preferred embodiment. With reference to this figure, in combination with FIGS. 1 and 2, upon detecting the presence an incoming tone signal on the telephone line 11, the caller telephone number is subsequently detected by the incoming call detector 32 of the controller 30 in the manner described beforehand. Then, with reference to the contents of the data storage unit 31, the comparator unit 33 determines whether the caller telephone number is associated with a rejected caller. In the affirmative, the comparator unit 33 controls the switch circuit 20 to break the connection between the telephone line 11 and the facsimile machine 10, and an end-of-file (EOF) signal is sent to the facsimile machine 10. Otherwise, the caller telephone number is shown on the display unit 50, and the transmission of the incoming fax message to the facsimile machine 10 proceeds uninterrupted. The incoming call is terminated upon detection of an end-of-file (EOF) signal.

In practice, there is a 50 ms time difference between the DTMF signal that contains the caller telephone number information and the ring signal. As detection of the caller telephone number and comparison thereof with the contents of the data storage unit 31 take about 150 ms, it is likely that a first ring signal will be received by the facsimile machine 10 before the status of the incoming call, e.g. rejected or accepted, can be determined by the controller 30. However, in the case of a rejected call, the receipt of the incoming call by the facsimile machine 10 can still be interrupted prior to the actual transmission of the incoming fax message.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A call screening device adapted to interconnect a facsimile machine and a telephone line, said call screening device comprising:
a switch circuit adapted to be connected to the facsimile machine and the telephone line; and
a controller coupled electrically to said switch circuit and adapted to be connected to the telephone line, said controller including
a data storage unit for storing telephone numbers,
an incoming call detector adapted to detect a caller telephone number associated with an incoming call on the telephone line, and
a comparator unit for making a comparison between the caller telephone number detected by the incoming call detector and the telephone numbers stored in said data storage unit, and for controlling said switch circuit to make or break connection between the facsimile machine and the telephone line according to result of the comparison made by said comparator unit.

2. The call screening device of claim 1, further comprising a keypad coupled electrically to said controller and operable so as to input the telephone numbers to be stored in said data storage unit.

3. The call screening device of claim 2, further comprising a display unit coupled electrically to and controlled by said controller to show the caller telephone number thereon.

4. The call screening device of claim 3, wherein said keypad is further operable so as to enable said controller to review the telephone numbers stored in said data storage unit and to control said display unit to show a reviewed one of the telephone numbers thereon.

5. The call screening device of claim 2, wherein said controller further includes a dual-tone multi-frequency signal generator for generating a dual-tone multi-frequency signal corresponding to the telephone number shown on said display unit for call back purposes.

6. The call screening device of claim 1, further comprising a display unit coupled electrically to and controlled by said controller for showing selected ones of the caller telephone number and the telephone numbers stored in said data storage unit thereon.

7. The call screening device of claim 1, wherein said incoming call detector includes a dual-tone multi-frequency decoder for detecting the caller telephone number that is associated with the incoming call on the telephone line.

8. The call screening device of claim 1, wherein said controller normally operates in a sleep mode, and further includes a tone detector that is adapted to detect presence of an incoming tone signal on the telephone line, and to wake said controller from the sleep mode upon detection of the incoming tone signal.

9. The call screening device of claim 1, wherein the telephone numbers stored in said data storage unit are associated with rejected callers, said comparator unit controlling said switch circuit to break connection between the facsimile machine and the telephone line when the caller telephone number corresponds to one of the telephone numbers stored in said data storage unit.

10. The call screening device of claim 1, wherein the telephone numbers stored in said data storage unit are associated with non-rejected callers, said comparator unit controlling said switch circuit to maintain connection between the facsimile machine and the telephone line when the caller telephone number corresponds to one of the telephone numbers stored in said data storage unit.
